(19) United States
(12) Patent Application Publication
(10) Pub. No.: US 2023/0032962 A1
(43) Pub. Date: Feb. 2, 2023

(54) REMOTELY CONTROLLING DEVICE OF PARTICIPANT IN ONLINE CHAT ROOM

(71) Applicant: INTHESMART Co., Ltd., Seoul (KR)

(72) Inventors: Choong Hee LEE, Seoul (KR); Il Hyung SHIN, Jeju-si (KR)

(73) Assignee: INTHESMART Co., Ltd., Seoul (KR)

(21) Appl. No.: 17/676,163

(22) Filed: Feb. 20, 2022

Related U.S. Application Data
(60) Provisional application No. 63/226,177, filed on Jul. 28, 2021.

(51) Int. Cl. H04N 21/2187; H04L 51/046; A61H 23/02

(52) U.S. Cl. CPC H04N 21/2187; H04L 51/046; A61H 23/02; A61H 2201/5012

(57) ABSTRACT

Systems and methods for remotely massaging a participant in a live streaming session. A method for remotely massaging a participant in a live streaming session includes: responsive to a login of a participant on a live streaming session of an online chat room via a network, displaying a username of the participant on a display; receiving the username of the participant and a counted number of tokens that are tipped to a host of the live streaming session by the participant; displaying the counted number of tokens and the username of the participant on a display; and responsive to a determination that the counted number of tokens exceeds a threshold value, sending a control signal to a massage device of the participant via the network so as to give a massage session to the participant.

### A. TECHNICAL FIELD

The present invention relates to a wireless communication, more particularly, to systems and methods for remotely controlling massage devices of participants during a live streaming session of an online chat room.

### B. DESCRIPTION OF THE RELATED ART

With advent of online communication technology, online chat rooms (or shortly, chat rooms) are readily available for synchronous conferencing to share information via text with a group of other participants, typically strangers to each other. Unlike the instant messaging programs, which are typically designed for one-to-one communications, a typical chat room allows multiple participants to converse simultaneously in the same conversation and caters to the participants with a wide range of subjects. In some chat rooms, a host, which is referred to as live streamer or broadcast jockey, streams games, music, singing, dancing, live talk sessions and sometimes sexually suggestive acts, and the participants (or, audiences) can actively engage into the conversation. Hereinafter, the term online chat room (or shortly, chat room) refers to a chat room for providing live streaming services.

Typically, the participants are anonymous and each participant in a chat room may enter a text message into a chat box of his/her chatting window. Then, the message is sent to the host and broadcast to other participants in the chat room so that all of the participants can share the message. Also, the host, who is on a web cam for broadcasting the video images of the host in real-time, responds to the messages from the participants. Typically, a participant may tip the host by sending a token(s), which can be cashed, during the live streaming session of the online chat room and, in response, the host may take an action, such as dancing or singing, in appreciation of gratitude.

The drawback of the conventional chat room is that, when a participant tips the host with token(s), the host is not able to take any action for only the participant. At best, the host may broadcast a verbal expression of her appreciation, stating the username of the participant. As such, the conventional chat room does not provide the host with any other suitable measures to express her appreciation only to a particular participant.

Thus, there is a need for systems and methods that allow the host to express her appreciation and/or provide a massage for only a participant who tips the host, making the participant feel more intimate with the host and get more satisfied during a live streaming session.

### SUMMARY OF THE INVENTION

In one aspect of the present invention, a system for remotely massaging a participant in a live streaming session includes: one or more processors; and a non-transitory computer-readable medium comprising one or more sequences of instructions which, when executed by the one or more processors, cause steps to be performed comprising: responsive to a login of a participant on a live streaming session of an online chat room via a network, displaying a username of the participant on a display; receiving the username of the participant and a counted number of tokens that are tipped to a host of the live streaming session by the participant; displaying the counted number of tokens and the username of the participant on a display; and responsive to a determination that the counted number of tokens exceeds a threshold value, sending a control signal to a massage device of the participant via the network so as to give a massage session to the participant.

In another aspect of the present invention, a computer-implemented method for remotely massaging a participant in a live streaming session includes: responsive to a login of a participant on a live streaming session of an online chat room via a network, displaying a username of the participant on a display; receiving the username of the participant and a counted number of tokens that are tipped to a host of the live streaming session by the participant; displaying the counted number of tokens and the username of the participant on a display; and responsive to a determination that the counted number of tokens exceeds a threshold value, sending a control signal to a massage device of the participant via the network so as to give a massage session to the participant.

In another aspect of the present invention, a non-transitory computer-readable medium or media comprising one or more sequences of instructions which, when executed by one or more processors, cause steps for remotely massaging a participant in a live streaming session comprising: responsive to a login of a participant on a live streaming session of an online chat room via a network, displaying a username of the participant on a display; receiving the username of the participant and a counted number of tokens that are tipped to a host of the live streaming session by the participant; displaying the counted number of tokens and the username of the participant on a display; and responsive to a determination that the counted number of tokens exceeds a threshold value, sending a control signal to a massage device of the participant via the network so as to give a massage session to the participant.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 (“FIG.”) shows a schematic diagram of a system for a live streaming session in an online chat room according to embodiments of the present disclosure.

FIG. 2 shows an exemplary display on a host's computer during a live streaming session according to embodiments of the present disclosure.

FIG. 3 shows an exemplary display on a participant's communication device during a live streaming session according to embodiments of the present disclosure.

FIG. 4 shows an exemplary online purchase order form for purchasing tokens for the online chat room according to embodiments of the present disclosure.

FIG. 5 shows a flowchart of an illustrative process for remotely controlling a device according to embodiments of the present disclosure.

FIG. 6 shows a flowchart of an illustrative process for remotely controlling a device according to embodiments of the present disclosure.

FIG. 7 shows a flowchart of an illustrative process for remotely controlling a device according to embodiments of the present disclosure.

FIG. 8 shows a schematic diagram of a system for implementing one or more aspects of the present disclosure.

### DETAILED DESCRIPTION OF PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components shown in the drawings are illustrative of exemplary embodiments of the present invention and are meant to avoid obscuring the invention. Furthermore, connections between components within the figures are not intended to be limited to direct connections. Rather, data between these components may be modified, re-formatted, or otherwise changed by intermediary components or devices. Also, additional or fewer connections may be used. It shall also be noted that the terms “coupled” “connected” or “communicatively coupled” shall be understood to include direct connections, indirect connections through one or more intermediary devices, and wireless and/or wired connections.

Furthermore, by applying relevant technology, one skilled in the art shall recognize: (1) that certain steps may optionally be performed; (2) that steps may not be limited to the specific order set forth herein; (3) that certain steps may be performed in different orders; and (4) certain steps may be done concurrently.

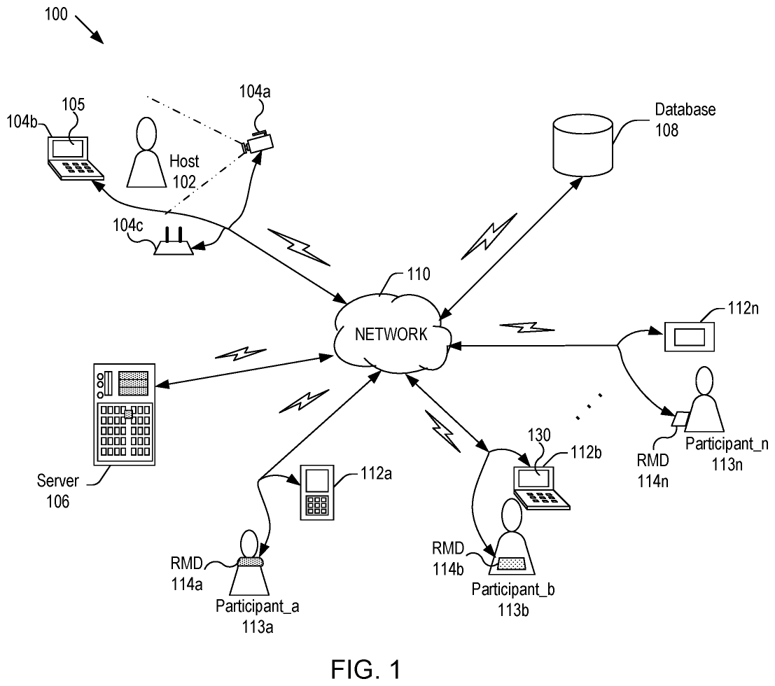

FIG. 1 shows a schematic diagram of a system 100 for a live streaming session in an online chat room according to embodiments of the present disclosure. As depicted, a live streamer (or equivalently host) 102 may communicate with the participants 113a-113n in the online chat room via a network, such as Internet, 110. The online chat room may run on a live streaming interactive platform, such as AfreecaTV® or Twitch® live streaming platform.

In embodiments, the host 102 may be on the web camera 104a that captures live video images of the host so that the participants 113a-113n in the online chat room can watch streaming video images of the host on their communication devices in real-time. In embodiments, the web camera 104a may be communicatively coupled to the network 110.

In embodiments, the host 102 may watch the display 105 on the screen of a device 104b to read the messages from the participants 113a-113n, and may respond to the messages during the line streaming session. In embodiments, the device 104b may be any suitable computing device that has a screen for presenting the display 105.

In embodiments, each participant (e.g. 113a) may log in the live streaming session, using his/her username as an identity. The server 106 may monitor the network 110 and, when the participant_a 113a joins the live streaming session, the server 106 may send the username of the participant_a 113a to the device 104b of the host. As discussed below, the username of the participant_a 113a may be displayed on display 105 of the host's device 104b. In embodiments, the server 106 may include the database 108 or be remotely located and communicatively coupled to the database 108 via the network 110. Both the server 106 and database 108 may be communicatively coupled to the network 110. In embodiments, the device 104b and the server 106 may form a computing device.

In embodiments, the server 106 may be the central controller for operating the live streaming session, such as opening the live streaming session, monitoring the participants and the status of the communication channels between the device 104b of the 102 and the communication devices 112a-112n of the participants 113a-113n, providing information of the participants for the host's device 104b, monitoring the communication channels to capture the messages exchanged during the live streaming session and broadcasting the messages to the devises 104b and 112a-112n, monitoring the communication channels to detect the tokens tipped by the participants, so on. The server 106 may store various information collected during operation of the live streaming session in the database 108.

In FIG. 1, the devices 104a-104c may be directly coupled to the network 110. In another embodiment, the devices 104a-104b may send data to or receive data from the network 110 via other suitable networking hardware devices, such as wireless access point 104c. in yet another embodiment, the devices 104a-104c may send data to or receive data from other suitable network, such as local area network (not shown in FIG. 1), which is communicatively coupled to the network 110.

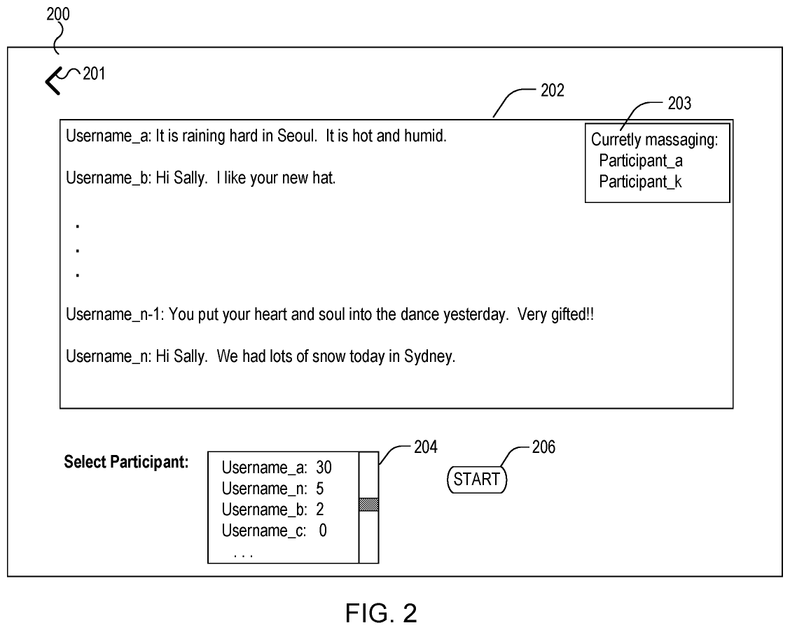

FIG. 2 shows an exemplary display 200 on the device 104b during a live streaming session according to embodiments of the present disclosure. As depicted, the display 200 may display multiple GUI components 201-206. It should be apparent to those of ordinary skill in the art that the display 200 may include other GUI components and the GUI components may be displayed in other suitable configurations. For instance, the GUI component 201 may allow the host to exit the display 200. In alternative embodiment, an EXIT button (not shown in FIG. 2) may be used in place of the GUI component 201 so that the host may exit the display 200.

In embodiments, the dialog box 202 may display the messages sent to the host 102 (whose name is Sally, for instance) from the communication devices 112a-112n of the participants 113a-113n, respectively. In embodiments, each participant may use his/her username as an identificaiton in the online chat room. For the purpose of illustration, it is assumed that the participants 113a-113n may respectively use the username_a-username_n. In embodiments, the host 102 may read and respond to the messages during the live streaming session, where the response of the host may be captured by the camera 104a and broadcast to the communication devices 112a-112n via the network 110. In embodiments, the response may include verbal comments, skits, massages, etc.

In embodiments, the host 102 may want to give a massage to a particular participant during the live streaming session of the online chat room. To allow the host to select a particular participant, the GUI component 204 may display a list of usernames of the participants 113a-113n who are currently logged in the live streaming session. In embodiments, the GUI component 204 may include a scroll bar that allows the host to scroll down the list and select a particular participant. Upon selecting a username among usernames in the GUI component 204, the host 102 may press the button 206 to send a remote control signal to the RMD of the selected participant. In embodiments, the remote control signal may control the RMD of the selected participant so as to give a massage session to the selected participant.

During the live streaming session, a participant may tip the host 102 with a token(s), where the participant may purchase the token online and use in lieu of cash during the live streaming session. In embodiments, each element in the GUI component 204 username list 204 may include the username of the participant and the number of tokens received from the participant in a reverse chronical order during the live streaming session. In embodiments, the host 102 may take various actions depending on the number of tokens received from a participant. For instance, the host 102 may verbally express his/her gratitude to the participant_b 113b when the number of tokens is low. In another example, the host 102 may verbally express his/her gratitude to the participant_n 113n and/or perform a skit when the number of tokens is in a medium range. In yet another example, the host 102 may verbally express his/her gratitude to the participant_a 113a and/or press the button 206 to remotely give a massage to the participant_a 113a when the number of tokens is high (or exceeds a threshold value).

In embodiments, when the number of tokens tipped by a participant (e.g. 113a) exceeds a threshold value, the host 102 may manually select a username (e.g. usename_a) among the list of usernames in the GUI component 204 and touch the START button 206. Then, the host device 104b (or the server 106) may send a remote control signal to the RMD 114a via the network 110 so that the RMD 114a may give a massage session to the participant_a 113a. In alternative embodiments, the host may use, instead of the host device 104b, a remote control (not shown in FIG. 1) to send a remote control signal to the RMD 114a via the local area network which is communicatively coupled to the network 110.

Upon completion of the massage session, the number of tokens displayed on the right-hand side of the username_a in the GUI component 204 may be reduced by a preset value. For instance, when the host 102 selects the username_a in the GUI component 204 and touches the button 206 to give a massage to the participant_a 113a, the number of token displayed on the GUI component may be reduced by the preset value after the massage session is completed.

In alternative embodiments, the server 106 may automatically send a remote control signal to the RMD of a participant (e.g. 113a) so as to give a massage session to the participant_a 113a when the number of tokens tipped by the participant_a 113a exceeds a threshold value. Upon completion of the massage session, the number of tokens displayed on the right-hand side of the username_a in the GUI component 204 may be reduced by a preset value.

In embodiments, each of the remote massage devices 114a-114n may be in physical contact with the corresponding participant so as to give a massage to the participant during the live streaming session. For instance, the RMD 114_a may give a neck massage to the participant_a 113a in response to the a remote control signal transmitted by the host's device 104b (or the server 106).

In embodiments, the GUI components 203 may show a list of participants who are currently being massaged by their RMDs. For instance, the GUI component 203 shows that two participants are currently massaged by their RMDs in response to the remote controls signals transmitted by the device 104b (or the server 106). In embodiments, the server 106 (or the device 104b) may update the list of participants each time a new massage session begins or a massage session is completed, and send the updated list to the device 104b.

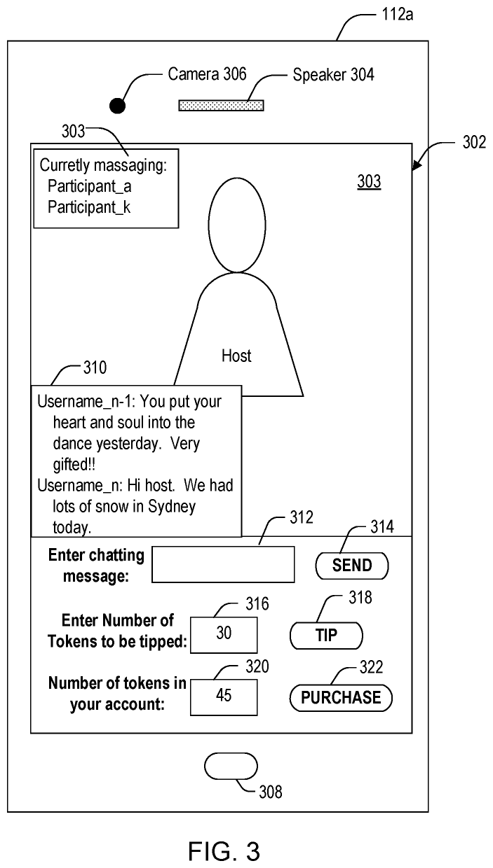

FIG. 3 shows an exemplary display 302 on the communication device 112a during a live streaming session according to embodiments of the present disclosure. As depicted, the device 112a may include: a speaker 304, a camera 306; and a button 308 for selecting various functions of the device 112a. In embodiments, the display 302 may include multiple GUI components: an image display 303 for displaying the streaming video images of the host 102 captured by the camera 104a during the live streaming session; a dialog box 310 for displaying the messages entered by the participants 113a-113n during the live streaming session; a text field 312 into which the participant_a 113a enters chatting messages; a SEND button 314 that the participant_a touches to send the chatting messages entered into the text field 312; a text field 316 into which the participant_a 113a enters the number of tokens to be tipped to the host 102; a TIP button 318 that the participant_a 113a touches to tip the host 102 with the tokens; a text field 320 that shows the number of tokens remaining in his/her account; and a “PURCHASE” button 322 that opens a new window when the participant_a 113a touches so as to allow the participant_a 113a to purchase tokens.

In embodiments, the streaming video images of the host 102 may be displayed in the image display 303 while the voice messages of the host may be displayed through the speaker 304 during the live streaming session. In embodiments, in response to receiving the tokens from a participant (e.g. 113a), the host 102 may express her gratitude on the camera and/or start a massage session for the participant_a 113a as discussed in conjunction with FIGS. 1 and 2.

In embodiments, each of the communication devices 112a-112n may be any suitable computing device, such as mobile phone, personal digital assistant (PDA), laptop computer, desktop computer, etc., that can display the streaming video and audio messages and present the GUI components in FIG. 3 that allow the participant to send the messages to the host and tip the host with the tokens. In embodiments, a participant may use his/her communication device to create an account for the online chat room and provide information related to the participant, where the information includes his/her username and information of the participant's RMD.

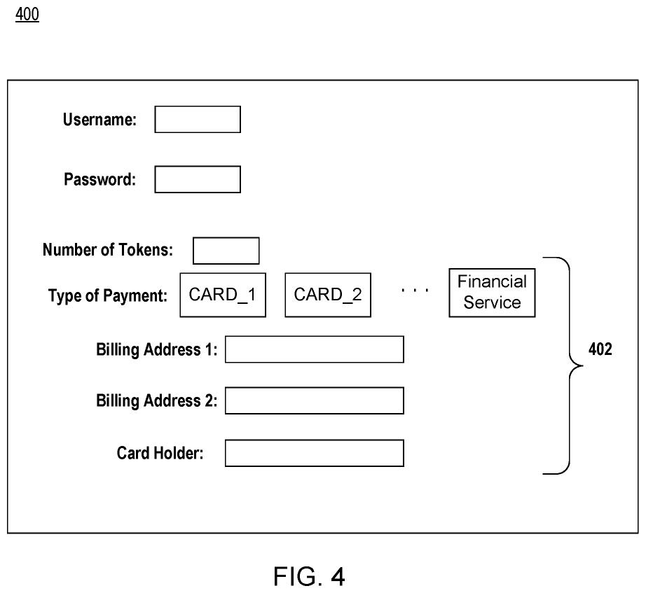

As discussed above, the participant may touch the PURCHASE button 322 to replenish his/her account with tokens. When the button 322 is touched, a sign-up form 400 may be displayed on the participant's communication device (e.g. 112a). FIG. 4 shows an exemplary online purchase order form (or shortly purchase order form) 400 for purchasing tokens for the online chat room according to embodiments of the present disclosure. In embodiments, the server 106 (or the host device 104b) may prepare the purchase order form 400 and present the purchase order form to the participant via the network 110, and the participant may purchase the token(s) by filing out and submitting the purchase order form to the server 106 (or the host device 104b). Upon completing the purchase, the server 106 may store the number of purchased tokens in the database 108 and update the total number of tokens in the participant's account into the database 108.

As depicted in FIG. 4, the purchase order form 400 may include several text fields for entering the username, password, and number of tokens to be purchased. The purchase order form 400 may also include a payment information section 402 that allows the participant to purchase the tokens using various payment measures, such as VISA™ online payment company, Paypal™ online financial service, etc. It is noted that the purchase order form 400 may include other GUI components and have various configurations in displaying the GUI components.

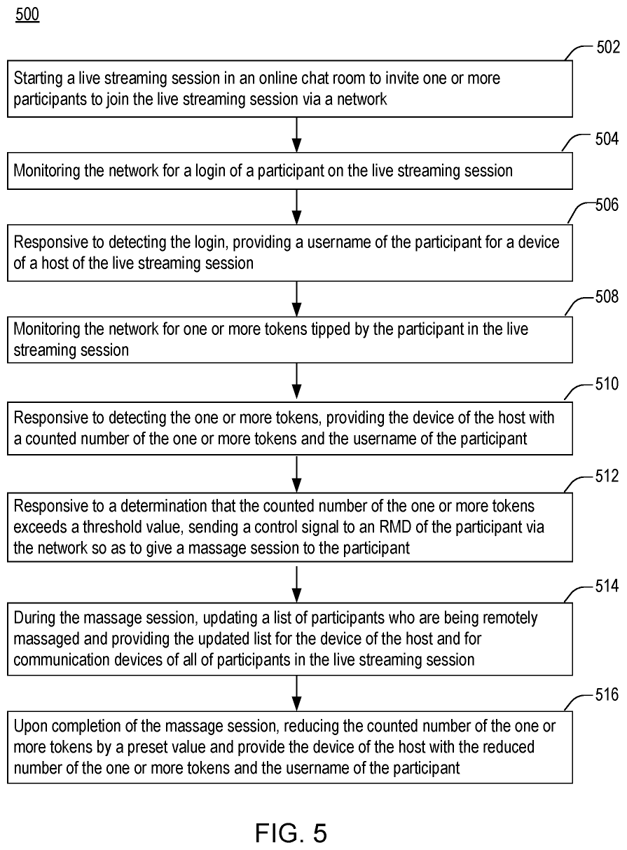

FIG. 5 shows a flowchart 500 of an illustrative process for remotely controlling a device according to embodiments of the present disclosure. In embodiments, the steps in the flowchart 500 may be performed by the server 106. At step 502, the server 106 may start a live streaming session in an online chat room so as to invite one or more participants 113a-113n to join the live streaming session via the network 110. Next, at step 504, the server 106 may monitor the network 110 for a login of a participant on the live streaming session. Responsive to detecting the login, at step 506, the server 106 may provide the username of the participant for the host's device 104b. In embodiments, the host's device 104b may add the username of the participant to the list in the GUI component 204.

At step 508, the server 106 may monitor the network 110 (or the communication channel between the host's device 104b and the communication device of a participant) for one or more tokens tipped by a participant in the live streaming session. Then, at step 510, responsive to detecting the one or more tokens, the server 106 may provide the host's device 104b with the counted number of the one or more tokens and the username of the participant who tips the token. Then, the host's device 104b may display the counted number of the one or more tokens right next to the username of the participant in the GUI component 204.

In embodiments, at step 512, the server 106 may determine whether the counted number of the one or more tokens exceeds a threshold value. When the counted number of the one or more tokens exceeds the threshold value, the server 106 may automatically send a remote control signal to the RMD of the participant via the network 110, to thereby give a massage session to the participant. In alternative embodiments, at step 512, the host 102 may watch the GUI component 204 to determine whether the counted number of the one or more tokens exceeds a threshold value. When the counted number of the one or more tokens exceeds the threshold value, the host 102 may select one username among the list of usernames in the GUI component 204 and manually press the START button 206. Then, the server 106 (or the host's device 104b) may send a remote control signal to the RMD of the selected participant via the network 110, to thereby give a massage session to the participant.

During the massage session, at step 514, the server 106 may update the list of participants who are being remotely massaged and provide the updated list for the device 104b of the host and for the communication devices 112a-112n of all of the participants in the live streaming session. Then, the updated list may be displayed on the GUI component 203 of the device 104b and the GUI components 303 of the communication devices (e.g. 112a) of all of the participants in the live streaming session.

At step 516, upon completing the massage session, the server 106 may reduce the counted number of the one or more tokens by a preset value. The server 106 may provide the device 104b of the host with the reduced number of tokens and the username of the participant. Then, the device 104b may display the reduced number on the right-hand side of the username in the GUI component 204.

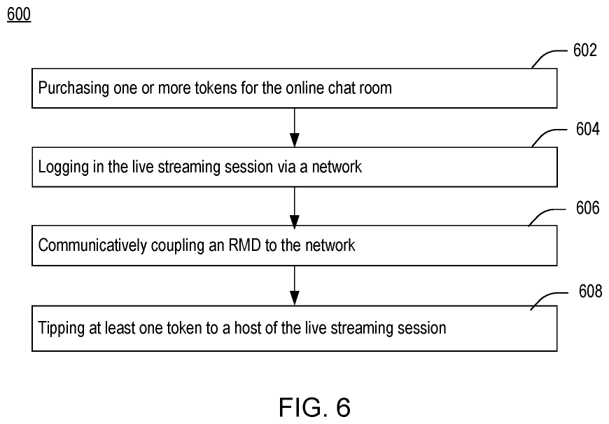

FIG. 6 shows a flowchart 600 of an illustrative process for remotely controlling a device according to embodiments of the present disclosure. In embodiments, the steps in the flowchart 600 may be performed by a participant (e.g. 113a). In embodiments, at step 602, the participant_a 113a may purchase one or more tokens for the online chat room using the online purchase order form 400. At step 604, the participant_a 113a may log in the live streaming session via the network 110. Next, at step 606, the participant_a 113a may communicatively couple the RMD 114a to the network 110. At step 808, the participant_a 113a may tip the host 102 of the live streaming session with at least one token. When the number of tokens tipped to the host 102 exceeds a threshold value, the server 106 (or the host's device 104b) may send a remote control signal to the RMD 114a to give a massage session to the participant_a 113a.

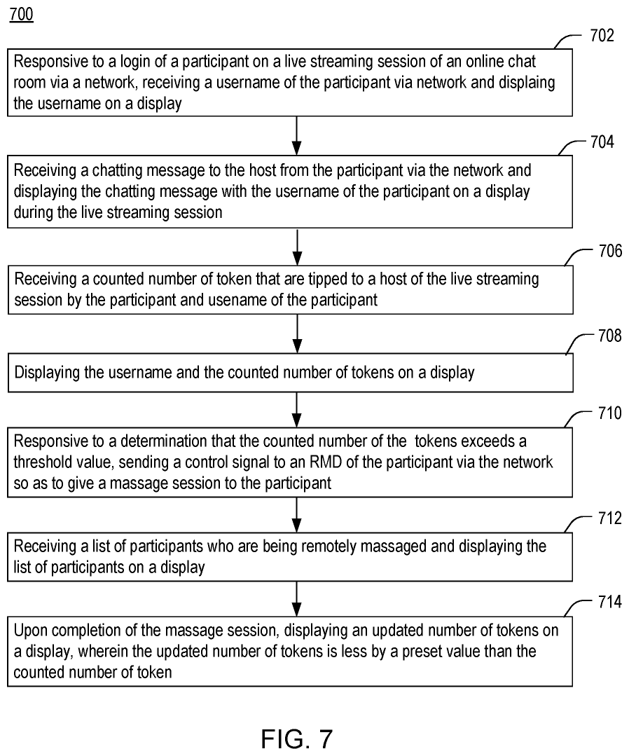

FIG. 7 shows a flowchart of an illustrative process 700 for remotely controlling a device according to embodiments of the present disclosure. In embodiments, the steps in the flowchart 700 may be performed by the host's device 104b. At step 702, the device 104b may display the username of a participant (e.g. 113a) on a display, such as GUI component 202, when the participant_a 113a logs in the live streaming session of an online chat room. In embodiments, the server 106 may monitor the network 110 for the login of the participant_a 113a on the live streaming session and provide the username of the participant_a 113a for the host's device 104b. In alternative embodiments, the device 104b may monitor the network 110 for the login of the participant_a 113a on the live streaming session. In the host 102 may greet the participant_a 113a when the username of the participant_a 113a is displayed on the GUI component 202.

At step 704, the device 104b may receive a message from the participant_a 113a and display the message with the username of the participant_a 113a on a display, such as the GUI component 202 during the live streaming session.

In embodiments, the server 106 (or the device 104b) may monitor the network for tokens tipped by the participant_a 113a. Responsive to detecting the tokens, the device 104b may receive the counted number of tokens and the username of the participant_a 113a, at step 706. Then, at step 708, the received counted number of tokens and the username may be displayed on a display, such as 204.

In embodiments, the host 102 may watch the GUI component 204 and take various actions depending on the number of tokens tipped by a participant. For instance, the host 102 may verbally express his/her gratitude to the participant when the number of tokens is low. In another example, the host 102 may verbally express his/her gratitude to the participant and/or perform a skit when the number of tokens is in a medium range. In yet another example, the host 102 may verbally express his/her gratitude to the participant and/or press the button 206 to remotely give a massage to the participant when the number of tokens is high (or exceeds a threshold value) at step 710.

At step 710, the host 102 may determine that the counted number of tokens tipped by the participant_a 113a exceed a threshold value. Then, the host 102 may select the participant_a 113a among the list of usernames in the GUI component 204 and press the button 206 when the number of tokens on the right-hand side of the username_a exceeds a threshold value. Subsequently, the device 104b may send a remote control signal to the RMD 114b so as to give a massage session to the participant_a 113a. In alternative embodiments, the device 104b may automatically send a remote control signal to the RMD 114b when the number of tokens on the right-hand side of the username_a exceeds a threshold value.

At step 712, the device 104b may receive a list of participants who are being remotely massaged and display the list on a display, such as GUI component 203. In embodiments, the server 106 (or the device 104b) may update the list of participants each time a new massage session begins or a massage session is completed, and send the updated list to the device 104b.

In embodiments, the number of tokens shown in the GUI component 204, which is tipped by the participant_a 113a, may be reduced by a present value each time a massage session is provided for the participant_a 113a. At step 714, upon completion of a massage session, the device 104b may display an update number of tokens that is less by the preset value than the counted number of tokens. In embodiments, the server 106 (or the device 104b) may calculate the reduced number of tokens and send the reduced number to the device 104b.

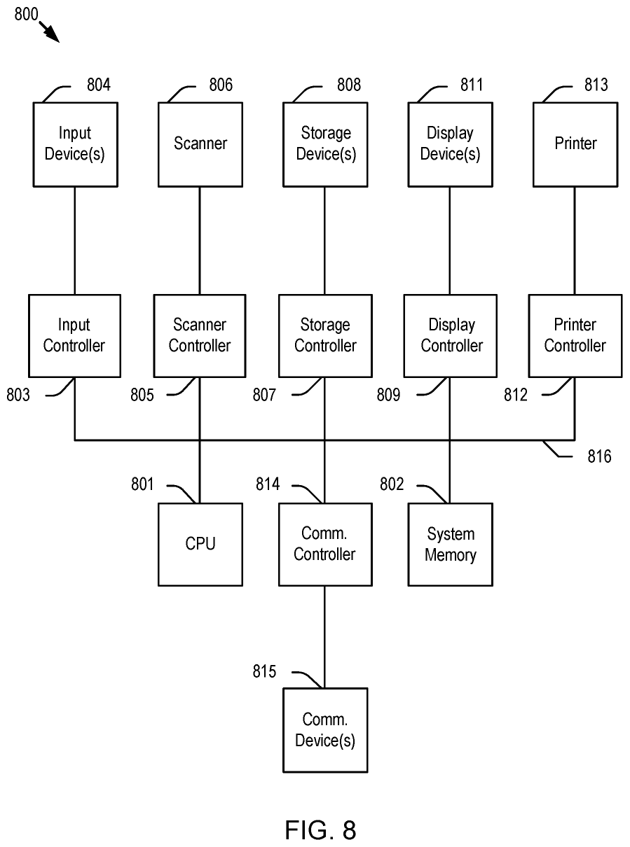

FIG. 8 shows a schematic diagram of a system 800 for implementing one or more aspects of the present disclosure. It will be understood that the functionalities shown for system 800 may operate to support various embodiments of the electronic devices (such as devices 104a-104c, 106, 108, 112a-112n, and 114a-114n) shown in FIGS. 1-4—although it shall be understood that an electronic device may be differently configured and include different components. As illustrated in FIG. 8, system 800 includes a central processing unit (CPU) 801 that provides computing resources and controls the computer. CPU 801 may be implemented with a microprocessor or the like, and may also include a graphics processor and/or a floating point coprocessor for mathematical computations. System 800 may also include a system memory 802, which may be in the form of random-access memory (RAM) and read-only memory (ROM).

A number of controllers and peripheral devices may also be provided, as shown in FIG. 8. An input controller 803 represents an interface to various input device(s) 804, such as a keyboard, mouse, or stylus. There may also be a scanner controller 805, which communicates with a scanner 806. System 800 may also include a storage controller 807 for interfacing with one or more storage devices 808 each of which includes a storage medium such as magnetic tape or disk, or an optical medium that might be used to record programs of instructions for operating systems, utilities and applications which may include embodiments of programs that implement various aspects of the present invention. Storage device(s) 808 may also be used to store processed data or data to be processed in accordance with the invention. System 800 may also include a display controller 809 for providing an interface to a display device 811, which may be a cathode ray tube (CRT), a thin film transistor (TFT) display, or other type of display. System 800 may also include a printer controller 812 for communicating with a printer 813. A communications controller 814 may interface with one or more communication devices 815, which enables system 800 to connect to remote devices through any of a variety of networks including the Internet, an Ethernet cloud, an FCoE/DCB cloud, a local area network (LAN), a wide area network (WAN), a storage area network (SAN) or through any suitable electromagnetic carrier signals including infrared signals.

In the illustrated system, all major system components may connect to a bus 816, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

What is claimed is:

1. A system for remotely massaging a participant in a live streaming session, comprising:
one or more processors; and
a non-transitory computer-readable medium comprising one or more sequences of instructions which, when executed by the one or more processors, cause steps to be performed comprising:
responsive to a login of a participant on a live streaming session of an online chat room via a network, displaying a username of the participant on a display;
receiving the username of the participant and a counted number of tokens that are tipped to a host of the live streaming session by the participant;
displaying the counted number of tokens and the username of the participant on a display; and
responsive to a determination that the counted number of tokens exceeds a threshold value, sending a control signal to a massage device of the participant via the network so as to give a massage session to the participant.

2. The system of claim 1, wherein the steps further comprise:
receiving a chatting message from the participant via the network; and
displaying the chatting message with the username of the participant on a display during the live streaming session.

3. The system of claim 1, wherein the step of sending a control signal comprises;
causing the host to send the control signal to the massage device via the network.

4. The system of claim 1, wherein the steps further comprise:
receiving a list of participants who are being remotely massaged; and
displaying the list of participants on a display.

5. The system of claim 1, wherein the steps further comprise:
upon completion of the massage session, displaying an updated number of tokens, wherein the updated number of tokens is less by a preset value than the counted number of token.

6. A computer implemented method for remotely massaging a participant in a live streaming session, comprising:
responsive to a login of a participant on a live streaming session of an online chat room via a network, displaying a username of the participant on a display;
receiving the username of the participant and a counted number of tokens that are tipped to a host of the live streaming session by the participant;
displaying the counted number of tokens and the username of the participant on a display; and
responsive to a determination that the counted number of tokens exceeds a threshold value, sending a control signal to a massage device of the participant via the network so as to give a massage session to the participant.

7. The computer implemented method of claim 6, further comprising:
receiving a chatting message from the participant via the network; and
displaying the chatting message with the username of the participant on a display during the live streaming session.

8. The computer implemented method of claim 6, wherein the step of sending a control signal includes;
causing the host to send the control signal to the massage device via the network.

9. The computer implemented method of claim 6, further comprising:
receiving a list of participants who are being remotely massaged; and
displaying the list of participants on a display.

10. The computer implemented method of claim 6, further comprising:
upon completion of the massage session, displaying an updated number of tokens on a display, wherein the updated number of tokens is less by a preset value than the counted number of token.

11. A non-transitory computer-readable medium or media comprising one or more sequences of instructions which, when executed by one or more processors, cause steps for remotely massaging a participant in a live streaming session comprising:
responsive to a login of a participant on a live streaming session of an online chat room via a network, displaying a username of the participant on a display;
receiving the username of the participant and a counted number of tokens that are tipped to a host of the live streaming session by the participant;
displaying the counted number of tokens and the username of the participant on a display; and
responsive to a determination that the counted number of tokens exceeds a threshold value, sending a control signal to a massage device of the participant via the network so as to give a massage session to the participant.

12. The non-transitory computer-readable medium or media of claim 11 further comprising one or more sequences of instructions which, when executed by one or more processors, cause steps to be performed comprising:
receiving a chatting message from the participant via the network; and
displaying the chatting message with the username of the participant on a display during the live streaming session.

13. The non-transitory computer-readable medium or media of claim 11, wherein the step of sending a control signal includes;
causing the host to send the control signal to the massage device via the network.

14. The non-transitory computer-readable medium or media of claim 13 further comprising one or more sequences of instructions which, when executed by one or more processors, cause steps to be performed comprising:
receiving a list of participants who are being remotely massaged; and
displaying the list of participants on a display.

15. The non-transitory computer-readable medium or media of claim 13 further comprising one or more sequences of instructions which, when executed by one or more processors, cause steps to be performed comprising:
upon completion of the massage session, displaying an updated number of tokens on a display, wherein the updated number of tokens is less by a preset value than the counted number of token.
